(19) United States
(12) Patent Application Publication
(10) Pub. No.: US 2006/0150322 A1
(43) Pub. Date: Jul. 13, 2006

(54) Patient transfer sheet

(76) Inventor: Brenda Schrepfer, Trinidad, CO (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/328,369

(22) Filed: Jan. 9, 2006

Related U.S. Application Data
(60) Provisional application No. 60/642,680, filed on Jan. 10, 2005.

(51) Int. Cl. A61G 7/14

(52) U.S. Cl. 5/81.1 T

(57) ABSTRACT

A patient transfer sheet comprising a nylon sheet for transferring a patient and having a first pair of loop handles and a second pair of loop handles for supplying and carrying the patient.

### CLAIM OF PRIORITY

This application claims benefit to Provisional Application No. 60/642,680, filed on Jan. 10, 2005, entitled “Patient Transfer Sheet,” which is incorporated by reference herein in its entirety.

### FIELD OF THE INVENTION

The present invention is directed to the field of patient transfer devices. In particular, the present invention is directed to a novel patient transfer sheet.

### BACKGROUND OF THE INVENTION

Safely moving patients from one location to another can be a dangerous activity for both the patient and medical staff. There have been a number of patents directed to the area of patient transfer devices.

U.S. Pat. No. 5,442,821 is directed towards a sling for a patient to be transferred including a trough of strong flexible sheet material having a bottom, opposite side walls and opposite end walls. The side walls are connected to the end walls at four corners with a reinforced edge extending along the side walls, end walls and around the four corners. A pair of flexible handle straps are connected to each of the side walls, each handle strap extending beyond the reinforced edge of each side wall and being adjacent one of the corners and a further handle strap is fixed to each of the end walls, each further handle strap being intermediate the corners of each end wall respectively and extending beyond the reinforced edge of each end wall. The invention discloses the ornamental design for a patient transfer apparatus, as shown and described in the patent.

U.S. Pat. No. 4,716,607 is directed to a patient transfer mat for aiding the moving of a patient who cannot move oneself. The mat includes a center section and a pair of wing sections integrally and hingedly attached thereto and adapted to be placed under the patient. The mat including grasping openings in each end with slots adjacent thereto for securing a strap therethrough to secure the patient to the mat. A pair of mats are placed under the patient to move the patient by sliding or lifting.

U.S. Pat. No. 5,148,558 is directed to an improved patient transfer sheet device includes a thin first sheet, having a low coefficient of friction for contacting inner surfaces thereof and substantially higher coefficients of friction for other surfaces contacting the first sheet, and a thin second sheet, fixedly connected to the first sheet. The device has a plurality of corner cuffs for releasably securing the device to a first supporting structure. A perforation, medially spaced lengthwise of a patient lying on the device, penetrates the first and second sheets such that the device can be divided and removed from under the patient without rolling or lifting the patient. A first modified transfer device provides a thin band having additional lengthwise perforations such that the device can be placed such that a patient can be transferred sidewise in a pre-selected direction and, subsequently, be transferred in the reverse direction. A second modified transfer device provides a thin sheet in an accordion-fold configuration such that the patient can be selectively transferred to either side after being placed on the device. A third modified transfer device provides a thin sheet in an accordion-fold configuration such that the patient can be transferred to either side and, subsequently, be transferred again to either side.

U.S. Pat. No. 5,649,329 is directed to a patient carrier unit for a person lifting and transporting device comprising a first and a second section mounted on opposite sides of a vertical shaft and capable to rotate with respect to a holding device. The first section including a belt for supporting the upper body portion of a person and the second section including a belt for supporting the legs of the person, the second section including an electrical drive for changing the vertical position of the leg supporting belt.

U.S. Pat. No. 4,837,874 is directed to a beam contained in a horizontal plane and suspended by a frame equipped with a lift and column on a vertical axis, with rotation of the beam in said horizontal plane, and equipped with at least one C-shaped body handling tong and preferably a plurality thereof and each adapted to pass beneath and at least partially under a person's body to lift the same, and characterized by instantly adjustable and immediately removable vertical height positioning means for suspending the body handling tongs.

It is an object of the present invention to provide a novel patent transfer sheet.

It is a further object of the present invention to provide a system in which a patient can be easily transferred using a transfer sheet.

It is another object of the present invention to provide a safe, simple, low-cost effective device used to transfer patients from one surface to another.

It is a further objective of this transfer sheet to reduce the chance of injury to patients and caregivers.

In a still further object of the present invention, to provide a method for transferring a patient.

### SUMMARY OF THE INVENTION

The present invention discloses a patient transfer sheet comprising: a nylon sheet for transferring a patient, having a first set of loop handles and a second set of loop handles for conveying the patient. Another embodiment of the present invention discloses a patient transfer sheet comprising: a bright nylon sheet for transferring a patient and having a first set of loop handles and a second set of loop handles for lifting and conveying the patient.

A still further embodiment of the present invention discloses a patient transfer sheet comprising: a substantially rectangular nylon sheet for transferring a patient defining a front portion and a rear portion, a first pair of loop handles affixed to the front portion and a second pair of loop handles affixed to the back for conveying the patient.

A further embodiment is a method for transferring a patient comprising the following steps: placing a patient to be transferred on a substantially rectangular sheet, having a front and rear portions; applying a first pair of handles on opposite sides of the front of the sheet and a second pair of handles on opposite sides of the rear portion where the handle pairs an be used to lift the patient.

### BRIEF DESCRIPTION OF THE FIGURES

FIG. 1 is an overhead view of the present invention.

FIG. 2 is a prospective view of the invention showing a patient transferred.

### DESCRIPTION OF THE PREFERRED EMBODIMENT

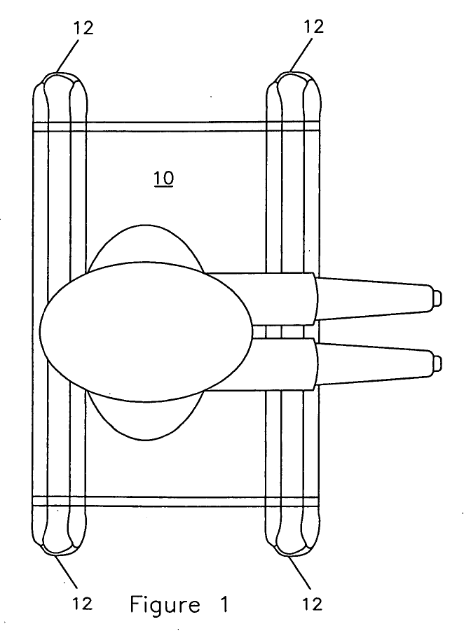

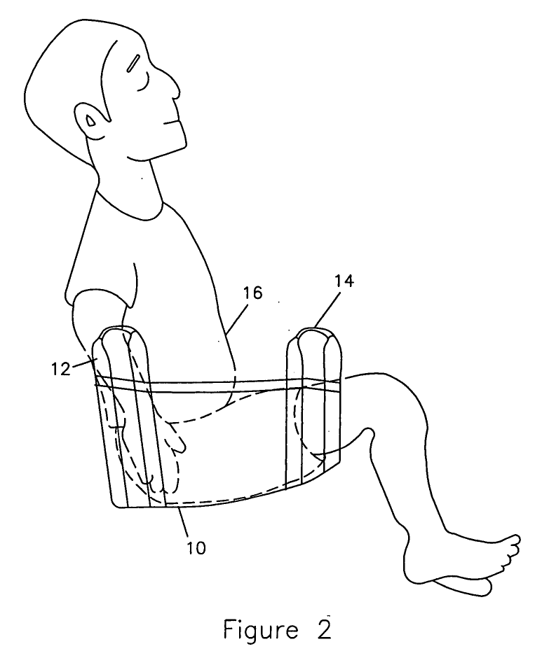

The present invention is described with reference to the enclosed Figures wherein the same numeration is used. Referring to FIGS. 1 and 2, the invention comprises a lightweight, washable, sheet 10 made from heavyweight cordura nylon which resists tearing. The device has two pairs 12, 14 of handles constructed from ripping and double 1½″ nylon webbing. The dimensions of the webbing may be altered. In a first embodiment, the sheet is substantially square or rectangular. The handles 12, 14 permit the invention to hang conveniently from wheelchair handles to doorknobs making it easily accessible for caregivers. In a preferred embodiment, the handles should comprise a double 1½″ nylon webbing. Bright colors make this device easy to locate in a facility and make it attractive to patients.

As shown in FIG. 2, the patient is preferably moved in a sitting position 16, The transfer sheet reduces the risk of joint and muscle injury, skin tears and bruising to patients as there is no direct lift technique touching the actual patient.

The present invention can have the following dimensions: for example, 48″×35½″ with 4 handles on each side or 40″×72″ with 6 handles on each side and one on each end.

The sheet of the present invention reduces the risk of injury to caregiver due to the ergonomically correct lift especially in challenging and hazardous lift scenarios. The invention is easy for facility staff members, home health providers and family members to use. The device is practical for the average family to use in a home caretaking situation. The invention suggests a method incorporating the apparatus.

The present invention has been described with reference to the enclosed figures. It is to be appreciated that the true nature and scope of the present invention is to be determined with reference to the attached claims.

1. A patient transfer sheet comprising:
a nylon sheet for transferring a patient;
a first set of loop handles and a second set of loop handles for conveying the patient.

2. A patient transfer sheet comprising:
a bright substantially rectangular nylon sheet for transferring a patient;
a first set of loop handles and a second set of loop handles for lifting and conveying the patient.

3. A patient transfer sheet comprising:
a substantially rectangular nylon sheet for transferring a patient, said rectangular sheet defining a front portion and a rear portion;
a first pair of loop handles affixed to the front portion; and a second pair of loop handles affixed to the rear portion for conveying the patient.

4. A method for transferring a patient comprising the following steps:
placing a patient to be transferred on a substantially rectangular sheet, having a front and rear portions;
applying a first pair of handles on opposite sides of the front portion of the sheet and a second pair of handles on opposite sides of the rear portion of this sheet where the first and second handle pairs can be used to lift the patient.
